(19) United States
(12) Patent Application Publication
(10) Pub. No.: US 2023/0066229 A1
(43) Pub. Date: Mar. 2, 2023

(54) BATTERY MODULE AND BATTERY PACK INCLUDING SAME

(71) Applicants: Hyundai Motor Company, Seoul (KR); Kia Corporation, Seoul (KR)

(72) Inventors: Seong Min HA, Uiwang-si (KR); Jong Chan Song, Uiwang-si (KR); Jae Wook Shin, Uiwang-si (KR); Seung Jong Lee, Uiwang-si (KR); Won Keun Kim, Uiwang-si (KR); Kyoung Han Ryu, Uiwang-si (KR)

(21) Appl. No.: 17/896,704

(22) Filed: Aug. 26, 2022

(30) Foreign Application Priority Data
Aug. 31, 2021 (KR) 10-2021-0115552

(51) Int. Cl. H01M 50/242; H01M 10/04

(52) U.S. Cl. CPC H01M 50/242; H01M 10/0481

(57) ABSTRACT

A battery module includes a plurality of unit cells stacked along a stacking direction thereof; and at least one pair of magnet members arranged to provide a compressive force to the stacked plurality of unit cells and magnetically coupled to each other.

### CROSS REFERENCE TO RELATED APPLICATION

The present application claims priority to Korean Patent Application No. 10-2021-0115552, filed Aug. 31, 2021, the entire contents of which is incorporated herein for all purposes by this reference.

### BACKGROUND OF THE PRESENT DISCLOSURE

### Field of the Present Disclosure

The present disclosure relates to a battery module and a battery pack including the same, and more particularly, to a lithium secondary battery module and a battery pack including the same.

### Description of Related Art

A lithium secondary battery is a high-performance secondary battery with high energy density and may be used in various fields including mobile devices and electric vehicles.

A battery module or battery pack in which a plurality of unit cells are electrically connected is applied to a machine, such as an electric vehicle requiring high output and large capacity. As the required output and energy density gradually increases, the number or size of unit cells included in the battery increases. In the instant case, the size of the battery is inevitably increased as well. Because the increase in size brings limitations when the installation space of the battery is limited, active research is being conducted to make the battery smaller and lighter while ensuring the battery has a large capacity and high output performance.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery module configured for reducing the thickness of a battery module or battery pack and a battery pack including the same.

Another objective of the present disclosure is to provide a battery module configured for increasing the lifespan of a lithium battery and a battery pack including the same.

The objective of the present disclosure is not limited to the objective mentioned above, and other objectives not mentioned are clearly understood by those of ordinary skill in the art (hereinafter referred to as ‘person of ordinary skill’) from the description below.

To achieve the objectives of the present disclosure as described above and perform the characteristic functions of the present disclosure to be described later, the features of the present disclosure are as follows.

According to an exemplary embodiment of the present disclosure, the battery module includes: a plurality of unit cells stacked along a stacking direction thereof; and at least one pair of magnet members arranged to provide a compressive force to the stacked plurality of unit cells and magnetically coupled to each other.

The present disclosure provides a battery module configured for reducing the thickness of a battery module or battery pack by suppressing an increase in the volume of a cell and a battery pack including the same.

According to an exemplary embodiment of the present disclosure, a battery module including a structure that increases the lifespan of a lithium battery and a battery pack including the same are provided.

The effects of the present disclosure are not limited to those described above, and other effects not mentioned will be clearly recognized by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1, FIG. 2, FIG. 3, FIG. 4, FIG. 5 and FIG. 6 show a battery module according to various embodiments of the present disclosure; and

FIG. 7 is a view for explaining an effect of the battery module according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Meanwhile, in the present disclosure, terms such as first and/or second may be used to describe various components, but the components are not limited to the terms. The above terms are used only for distinguishing one element from other elements, for example, within the scope of not departing from the scope of the rights according to the concept of the present disclosure, the first element may be named as the second element. Similarly, the second component may also be referred to as the first component.

When a component is referred to as being “connected” or “connected” to another component, it should be understood that other components may be directly connected to or connected to them but that other component may exist in the middle. On the other hand, when a component is referred to as being “directly connected” or “indirect contact” with another component, it should be understood that no other component exists in the middle. Other expressions for describing the relationship between components, such as “between” and “right between” or “adjacent to” and “directly adjacent to,” should also be interpreted.

Like reference numbers refer to like elements throughout. On the other hand, the terms used herein are for describing the exemplary embodiments and are not intended to limit the present disclosure. In the present specification, the singular form also includes the plural form unless otherwise specified in the phrase. As used in the specification, “comprises” and/or “comprising” do not preclude the presence or addition of one or more other elements, steps, operations, and/or devices mentioned in the device.

The objective of the present disclosure is to provide a battery module including a structure configured for improving the lifespan of a lithium secondary battery and reducing its size. The present disclosure aims to improve the lifespan of the battery by including a magnet in the battery module and reducing the thickness of the battery module.

The present disclosure can have a positive effect on increasing the lifespan of a lithium secondary battery by introducing a structure configured for applying an external magnetic field to the battery module to control the electrodeposition shape of lithium.

Furthermore, when a lithium metal battery is applied to a conventional battery module or pack as it is, the thickness of a case in the module or pack must be thick to counteract large pressure increase caused by the large volume increase of the lithium metal battery. Instead of increasing the thickness of the case, according to an exemplary embodiment of the present disclosure, the thickness of the case in the module or pack may be reduced by a predetermined level by suppressing a volume increase of unit cells in the module or pack by the introduction of the magnet, providing advantages in energy density per volume and/or per weight.

Hereinafter, the present disclosure will be described in detail with reference to the accompanying drawings.

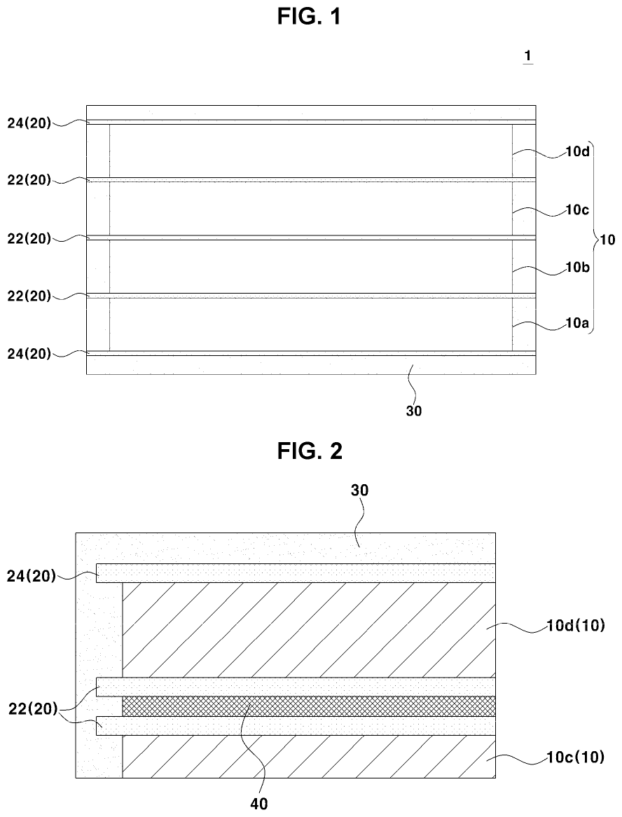

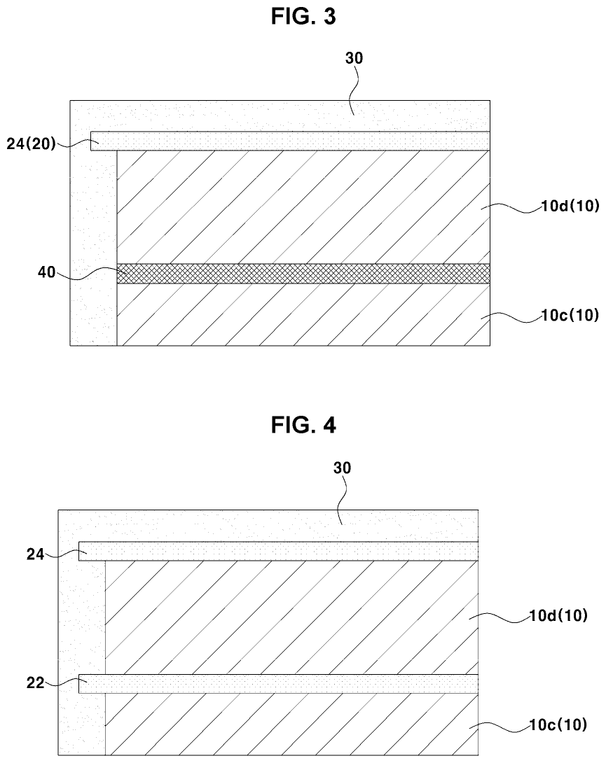

As shown in FIG. 1, the battery module 1 according to an exemplary embodiment of the present disclosure, includes a plurality of unit cells 10 and a magnet member 20.

Among the plurality of unit cells 10, each unit cell 10 includes an anode, a cathode, an electrolyte, and a separator. The anode may include lithium metal. Because the structure of a unit cell of a lithium secondary battery is well known, a description thereof will be omitted herein.

A plurality of unit cells 10 is sequentially stacked. For example, the plurality of unit cells 10 are sequentially stacked along a predetermined stacking direction. Although four unit cells 10 are illustrated in the drawing, the number of unit cells 10 is not limited thereto, and the number may be increased or decreased as necessary. Hereinafter, the unit cells 10 disposed at end portions of the battery module 1 in a vertical direction of the battery module 1, that is, the unit cells 10 positioned at end portions of the battery module 1 and in contact with only one unit cell 10, are referred to as end unit cells 10a, 10d. Furthermore, the unit cells 10 adjacent to the end unit cells 10a, 10d or the unit cells 10 located between two unit cells 10 will be referred to as intervening unit cells 10b, 10c. For example, in FIG. 1, the lowermost unit cell may be a first unit cell 10a, the unit cell above the first unit cell 10a may be a second unit cell 10b, the unit cell stacked on the second unit cell 10b may be referred to as a third unit cell 10c, and the unit cell stacked on the third unit cell 10c may be referred to as a fourth unit cell 10d. In the present example, the first unit cell 10a and the fourth unit cell 10d become the end unit cells 10a, 10d, and the second unit cell 10b and the third unit cell 10c become the intervening unit cells 10b, 10c.

The magnet member 20 is a magnetic material and may include a permanent magnet, an electromagnet, or the like. Alternatively, the magnet members 20 may be a material that interacts with other magnetic materials around it and forms a magnetic field.

The magnet member 20 may directly contact with the unit cells 10. According to an exemplary embodiment of the present disclosure, the magnet member 20 includes one or more intervening magnets 22 disposed on at least one side of the intervening unit cells 10b, 10c. The intervening magnet 22 may be provided between one intervening unit cell 10b, 10c and another neighboring intervening unit cell 10b, 10c.

As shown in FIG. 2, according to an exemplary embodiment of the present disclosure, the magnet member 20 includes one or more end magnets 24. The end magnet 24 may be disposed on a side where the end unit cells 10a, 10d are not adjacent to the other unit cells 10 (hereinafter, the non-adjacent side of the end unit cells 10a, 10d).

As described above, in the present specification, only for convenience of explanation the magnet member 20 in which the unit cells 10 are disposed on both sides of the magnet member 20 is referred to as the intervening magnet 22, and the magnet member 20 in which the unit cell 10 is disposed at one side thereof is referred to as the end magnet 24.

The battery module 1 including the stacked unit cells 10 and the magnet member 20 is surrounded by the frame 30. The frame 30 may maintain the shape of the battery module 1. The frame 30 may be made of a material resistant to tensile forces.

According to various exemplary embodiments of the present disclosure, one or more volume cushioning materials 40 may be further included. The volume cushioning material 40 may be disposed between the unit cells 10. According to various exemplary embodiments of the present disclosure, the volume cushioning material 40 may be disposed between the unit cells 10 to directly contact each unit cell 10. Furthermore, according to another exemplary embodiment of the present disclosure, the volume cushioning material 40 may be disposed between the unit cells 10, while each side of the volume cushioning material 40 may be disposed not to directly contact with the unit cells 10.

According to various exemplary embodiments of the present disclosure, the volume cushioning material 40 may be provided on the non-adjacent side or a free side of the end unit cells 10a, 10d. According to various exemplary embodiments of the present disclosure, the volume cushioning material 40 may be provided both between the unit cells 10 and on the free sides or the non-adjacent sides of the end unit cells 10a, 10d. Furthermore, according to various exemplary embodiments of the present disclosure, the volume cushioning material 40 may be provided only on the free sides of the end unit cells 10a, 10d.

Continuing to refer to FIG. 2, according to an exemplary embodiment of the present disclosure, the volume cushioning material 40 may be disposed between the intervening magnets 22 of the magnet member 20. The intervening magnets 22 of the magnet member 20 may be disposed on opposite sides of the volume cushioning material 40 disposed between the unit cells 10, respectively.

As shown in FIG. 3, according to an exemplary embodiment of the present disclosure, the volume cushioning material 40 may be disposed between the unit cells 10 without the magnet member 20. In the present form, the magnet member 20 is disposed only on the non-adjacent side or the free side of the end unit cells 10a, 10d, and only the volume cushioning material 40 may be disposed between the unit cells 10.

As shown in FIG. 4, according to an exemplary embodiment of the present disclosure, the volume cushioning material 40 may be omitted. Only the magnet member 20 is disposed between the unit cells 10, and only the magnet member 20 may be disposed on the non-adjacent side of the end unit cells 10a, 10d without the volume cushioning material 40.

As shown in FIG. 5, according to an exemplary embodiment of the present disclosure, the magnet member 20 disposed on the non-adjacent side or the free side of the end unit cells 10a, 10d may be disposed not to directly contact with the end unit cells 10a, 10d. According to an exemplary embodiment of the present disclosure, the end magnet 24 disposed on the non-adjacent side of the end unit cell 10d is disposed in the frame 30 spaced from the end unit cell 10d with a predetermined distance. According to another exemplary embodiment of the present disclosure, a magnet member 24′ disposed near to the free side of the end unit cell 10d may be disposed outside the frame 30 spaced from the end unit cell 10d with a predetermined distance. In the instant case, the intervening magnet 22 may or may not be disposed between the unit cells 10.

Referring to FIG. 6, the magnet member 20 may be disposed on opposite sides of the frame 30 in a direction perpendicular to the unit cell 10. That is, the magnet member 20 may be disposed to lie next to several unit cells 10. In the instant case, the magnet member 20 may or may not be disposed between the unit cells 10. Furthermore, the magnet member 20 may be mounted on the frame 30 spaced from the unit cell 10 with a predetermined distance or may be mounted on the frame 30 in contact with the unit cell 10.

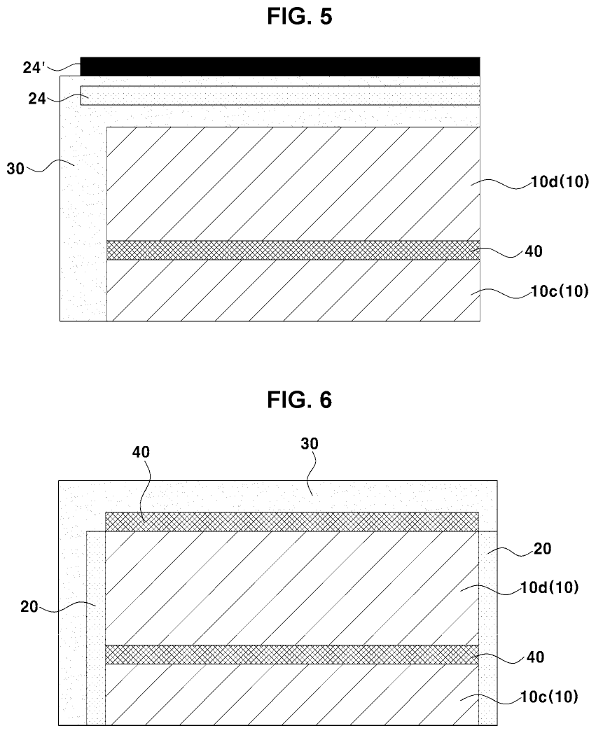

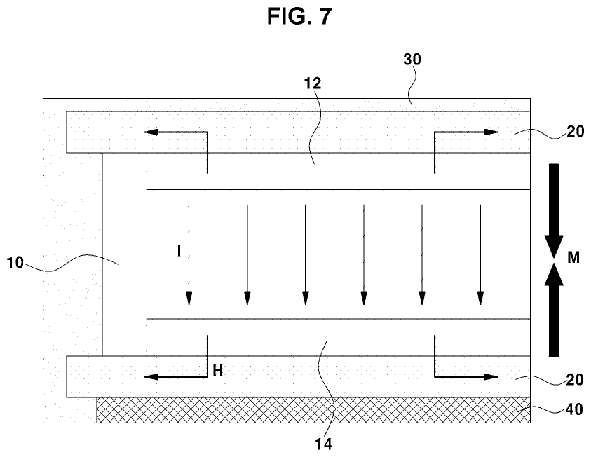

The operation and effect of the battery module and the battery pack, including the same according to an exemplary embodiment of the present disclosure, will be described with reference to FIG. 7.

As indicated by arrow I, lithium ions move from cathode 12 to anode 14 of the unit cell 10 during the operation of the battery. Due to the external magnetic field generated by the magnet member 20, the movement of lithium ions is changed under the influence of Lorentz's force. Accordingly, lithium may be electrodeposited evenly. Therefore, according to an exemplary embodiment of the present disclosure, the electrochemical reversibility of lithium may be improved, and volume increase may be relatively suppressed.

Furthermore, the heat generated while the battery is operating is directed to the frame 30 through the magnet member 20 (see arrow H). This allows the heat to be rapidly dissipated to the outside of the cell and provides an advantage in terms of thermal management of the cell.

Furthermore, according to an exemplary embodiment of the present disclosure, because the unit cell 10 is pressed with a constant force due to the attraction force (arrow M) generated by the magnet member 20, the unit cell 10 may be pressed with an appropriate pressure to improve performance and suppress a volume change.

When a volume change notwithstanding the volume suppression effect provided by the magnetic force occurs, the volume cushioning material 40 compensates for the present volume change. Through this, the battery module 1 according to an exemplary embodiment of the present disclosure can retain structural resistance to the internal physical stress generated during battery operation.

According to an exemplary embodiment of the present disclosure, an appropriate pressure may be applied to the unit cell 10 by the sole attraction of the magnet member 20 based on the magnetic field strength of the magnet member 20. Thus, a cell fixing form used in an existing jig may be changed, and the number of components may be reduced to lower weight.

Furthermore, according to an exemplary embodiment of the present disclosure, because the magnet member 20 directly contacting with the unit cell 10 has high thermal conductivity compared to a volume cushioning material used generally, heat generated during a charging and discharging process of a battery is rapidly transferred to the frame 30 to expect fast cooling.

According to an exemplary embodiment of the present disclosure, as the magnet member (permanent magnet or electromagnet) is integrated into the module or the pack, a magnetic field is applied to the cell 10 therein, and thus the movement of lithium ions is affected by the Lorentz's force, and lithium is uniformly electrodeposited/deintercalated.

Furthermore, in the present disclosure, the present uniform lithium electrodeposition/desorption shape minimizes volume increase, unlike a lithium battery using modules or packs of other conventional structures, reducing internal stress caused by volume changes. The frame 30 designed to withstand the reduced stress may be made thinner to reduce the volume or reduce the weight. This volume/weight reduction can further lead to an effect of increasing energy density.

The uniform lithium electrodeposition/desorption shape can reduce the side reaction area with the electrolyte, suppress the formation of unusable lithium, and provide a positive effect on increasing the lifespan of the lithium battery.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery module comprising:
a plurality of unit cells stacked along a stacking direction thereof; and
at least one pair of magnet members arranged to provide a compressive force to the stacked plurality of unit cells and magnetically coupled to each other.

2. The battery module of claim 1, further including a frame surrounding and supporting the plurality of unit cells and the at least one pair of magnet members.

3. The battery module of claim 1,
wherein the at least one pair of magnet members include end magnets, and
wherein each of the end magnets is disposed at first and second end portions of the plurality of unit cells in the stacking direction, respectively.

4. The battery module of claim 3, wherein the at least one pair of magnet members further include one or more intervening magnets disposed between the unit cells adjacent to each other.

5. The battery module of claim 3, further including one or more volume cushioning materials disposed between the unit cells adjacent to each other.

6. The battery module of claim 4,
wherein the unit cells adjacent to each other include a first unit cell and a second unit cell adjacent to the first unit cell with a predetermined gap, and
wherein the one or more intervening magnets includes:
a first intervening magnet disposed on a side of the first unit cell; and
a second intervening magnet disposed on a side of the second unit cell facing the side of the first unit cell, and
wherein the one or more intervening magnets includes a volume cushioning material disposed between the first intervening magnet and the second intervening magnet.

7. The battery module of claim 3, further including:
a frame surrounding the plurality of unit cells and the at least one pair of magnet members; and
the end magnets of the plurality of magnet members disposed between end unit cells of the plurality of unit cells and the frame.

8. The battery module of claim 3, further including:
a frame surrounding the plurality of unit cells and the at least one pair of magnet members; and
additional end magnets respectively disposed at an external side of each end unit cell of the plurality of unit cells disposed at the first and second end portions of the plurality of unit cells in the stacking direction.

9. The battery module of claim 8, wherein each of the end magnets is spaced from the respective end unit cell located within the frame with a predetermined distance from the respective end unit cell.

10. The battery module of claim 8, wherein each of the end magnets is disposed in the frame.

11. The battery module of claim 8, wherein each of the end magnets is disposed in a body of the frame.

12. The battery module of claim 8, wherein each of the additional end magnets is disposed at an external side of the frame.

13. The battery module of claim 1, wherein the at least one pair of magnet members is disposed at first and second end portions of the plurality of unit cells in a direction perpendicular to the stacking direction, respectively.

14. The battery module of claim 13, wherein one or more volume cushioning materials are disposed between the unit cells adjacent to each other in the stacking direction.

15. The battery module of claim 13, further including:
a frame surrounding the plurality of unit cells and the at least one pair of magnet members,
wherein one or more volume cushioning materials are disposed between an end unit cell among the unit cells and the frame.

16. The battery module of claim 1, wherein the battery module is for a lithium secondary battery.
